(19) United States
(12) Patent Application Publication
(10) Pub. No.: US 2009/0059463 A1
(43) Pub. Date: Mar. 5, 2009

(54) MULTI-VALUE CAPACITOR WITH SAFETY DISCONNECT MECHANISM

(76) Inventor: Charles Barry Ward, Alphareta, GA (US)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/173,154

(22) Filed: Jul. 15, 2008

Related U.S. Application Data
(60) Provisional application No. 60/968,110, filed on Aug. 27, 2007.

(51) Int. Cl. H01G 2/14

(52) U.S. Cl. 361/275.2

(57) ABSTRACT

A multi-value capacitor with a safety disconnect mechanism has a capacitive element with six capacitive sections, a common wire, and six section wires enclosed in a cylindrical metal can with a metal lid that normally has a concave configuration. The wires are soldered to contacts extending through the concave metal lid. The safety disconnect mechanism includes an external insulator disk with terminals. The terminals in the insulator disk align with the contacts in the metal lid. The center common terminal of the insulator disk is fixedly riveted to the center common contact of the metal lid. Spring elements form the electrical connection between the section terminals of the insulator disk and the section contacts in the metal lid. If an overload condition occurs, pressure inside the sealed metal can causes the metal lid to spring from its concave configuration to a convex configuration, which causes the whole insulator disk to pop up and thereby simultaneously break the connection between all of the section contacts in the metal lid and the section terminals of the insulator disk.

### CLAIM OF PRIORITY

This application claims priority from U.S. Provisional Patent Application Ser. No. 60/968,110 filed on Aug. 27, 2007, which is incorporated herein in its entirety.

### FIELD OF THE INVENTION

This invention relates to a multi-value motor run capacitor for an electric motor. More particularly, the invention relates to a multi-value motor run capacitor with a safety disconnect mechanism that interrupts the circuit between the motor and multi-value capacitor if the multi-value capacitor fails.

### BACKGROUND OF THE INVENTION

A distributor for electric motors currently carries several motor run capacitors of different values that must be stocked to fill the service chain. Service technicians and distributors must stock motor run capacitors of different values even though only a few values are high volume.

A motor run capacitor consists of a steel can or an aluminum can with insulator/connections on the top and with a capacitor element inside. The can is filled with oil or paraffin that acts as a moisture barrier and an electrical insulator for the capacitor element. The capacitor element consisting of two foil layers separated by an insulator (paper, Mylar, or other very thin insulating material). The foil(s) and insulating material are made in the form of a long sandwich 2 or 3 inches high and several 10's of feet long. The sandwich is rolled to form a cylindrical shaped capacitor element that has electrical connections to each of the two foils. The rolled capacitor element is typically 1 inch in diameter and 2 or 3 inches long. The rolled capacitor element is placed into the can and connected through two terminals on the outside of the can.

Dual capacitors are made with a similar construction, but one of the foil layers is separated to form two capacitor elements. An additional lead wire is connected to the third foil. A dual capacitor with asymmetrical capacitance values can be configured to create a three value capacitor by connecting the first element, the second element, or both elements in parallel.

Because a large portion of the cost of a motor run capacitor is in the can, the winding element, the packaging, and general handling, a single capacitor that can be configured to provide different values offers cost advantages over stocking multiple capacitors of different values.

A motor run capacitor having multiple values should also have a safety disconnect in case of failure either of the motor or the capacitor itself. When a failure occurs, heat and pressure may build up within the capacitor's can. Unless a safety disconnect is provided, the pressure may build until such time as the can ruptures creating a substantial hazard resulting from the spillage of hot oil from the can. Prior art safety disconnect mechanisms typically are located inside of the capacitor can. Consequently, disconnect arcing in the presence of high pressure oil vapor can lead to fire or explosion. The potential to arc is further exacerbated by the fact that the prior art safety disconnect mechanisms often rely on a slowly stretched link of wire. Single value capacitors and dual value capacitors likewise may experience the same failure mode as multi-value capacitors.

### SUMMARY OF THE INVENTION

The multi-value motor capacitor with a safety disconnect mechanism of the present invention is constructed in a single can having a core with six capacitor elements. When the capacitor elements are connected to the electric motor in various parallel and serial combinations, the motor run capacitor provides virtually all of the popular capacitance values required. Therefore one SKU part number covers the majority of motor run capacitor applications.

The multi-value motor run capacitor comprises a cylindrical metal can with a sealable metal lid. A capacitive element with six sections, each section having a capacitance value, is positioned within the cylindrical metal can. One terminal of each of the six sections is connected to a common wire, and the other terminal of each of the six sections is connected to one of six section wires. The common wire is soldered to a common contact located in the center of the capacitor's metal lid. The center common contact is fixed to the metal lid, is fluid tight, and provides an electrical path from the inside of the metal lid to the outside of the metal lid. Each of the six section wires is soldered to one of six similar fixed section contacts spaced around the periphery of the metal lid. The section contacts similarly are fixed to the metal lid, are fluid tight, and provide an electrical path from the inside of the metal lid to the outside of the metal lid.

In order to provide a safety disconnect mechanism, the multi-value capacitor also includes an external insulator disk positioned adjacent the metal lid. The insulator disk has a center common terminal and six section terminals spaced about its periphery all respectively in alignment with the common contact and the section contacts in the metal lid. The center common terminal of the insulator disk is fixedly riveted to the center common contact of the metal lid. Spring elements form the electrical connections between the section terminals of the insulator disk and the section contacts in the metal lid. Lead wires to the electric motor are connected in various parallel and serial combinations to the common terminal and the section terminals of the insulator disk.

The metal lid is dished downwardly (concave) to provide an “over-center” pop-spring (hysteresis) action. When the metal lid is crimped onto the cylindrical metal can, the downward dish of the metal lid pulls the insulator disk, by means of the center rivet or post, toward the metal lid so that the spring elements are compressed between the section terminals of the insulator disk and the section contacts about the periphery of the metal lid to form electrical paths from the section wires through the section contacts to the section terminals.

If an overload condition occurs with respect to the capacitor and sufficient pressure builds inside the sealed metal can, the metal lid springs from its concave configuration to a convex configuration. The spring action of the metal lid causes the insulator disk to pop up and thereby simultaneously break the connection between all of the section contacts in the metal lid and the section terminals of the insulator disk. The safety disconnect mechanism of the present invention thus moves any arcing of disconnecting contacts outside of the can and away from the atmosphere inside the can that might be combustible. Further the spring action of the metal lid provides a rapid and simultaneous disconnection of all periphery terminals thereby reducing the risk of arcing.

The safety disconnect mechanism of the present invention also has applicability to single value as well as dual value capacitors.

Each of the seven terminals on the insulator disk has an individual insulator cup formed around the terminal.

Further objects, features and advantages will become apparent upon consideration of the following detailed description of the invention when taken in conjunction with the drawing and the appended claims.

### BRIEF DESCRIPTION OF THE DRAWINGS

FIG. 1 is a cross-section view of the multi-value capacitor in accordance with the present invention showing the capacitor in its normal, connected state with the metal lid in a concave configuration.

FIG. 2 is a cross-section view of the multi-value capacitor in accordance with the present invention showing the capacitor in its expanded, disconnected state with the metal lid in a convex configuration.

FIG. 3 is a top plan view of the multi-value capacitor in accordance with the present invention.

FIG. 4 is a detailed, perspective view of an alternative section contact of the multi-value capacitor in accordance with the present invention, showing the section contact in its normal, connected state.

FIG. 5 is a detailed, perspective view of the alternative section contact of the multi-value capacitor in accordance with the present invention, showing the section contact in its disconnected state.

### DETAILED DESCRIPTION OF THE PREFERRED EMBODIMENT

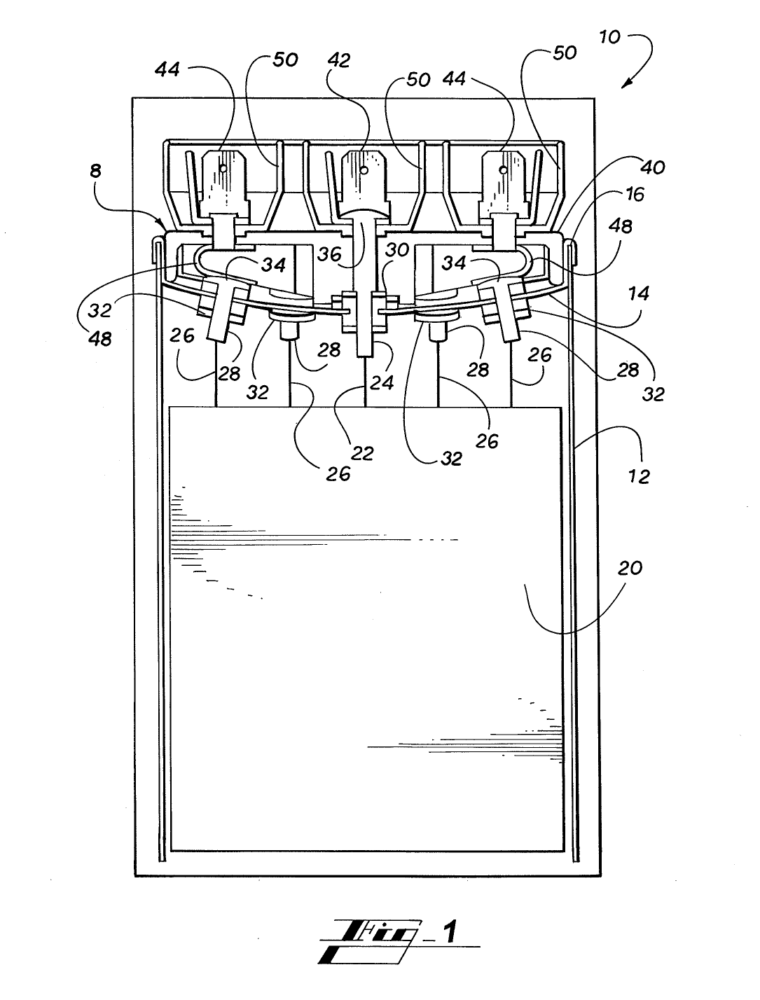

Turning to FIG. 1, the multi-value capacitor 10 of the present invention comprises a cylindrical metal can 12 with a metal lid 14. The metal lid 14 is fixed to the cylindrical metal can 12 by a crimp joint 16 around the periphery of the top of the metal can 12. When crimped in place on the top of the metal can 12, the metal lid 14 seals the can 12. The metal lid 14 has a concave profile as shown in FIG. 1. A capacitive element 20 with six capacitive sections (not individually shown) is positioned within the sealed cylindrical metal can 12. Each capacitive section has a capacitance value. The metal can 12 is filled with an insulating fluid such as oil, vegetable oil, or paraffin wax.

One terminal of each of the six capacitive sections is connected to a common wire 22, and the other terminal of each of the six capacitive sections is connected to one of six section wires 26. The common wire 22 is soldered to a common contact 24 located in the center of the capacitor's metal lid 14. The center common contact 24 extends through the metal lid 14 and is fixed to the metal lid 14 by means of a common contact seal 30. The common contact seal 30 is fluid tight and insulates the common contact 24 from the metal lid 14. The common contact 24 provides an electrical path from the inside of the metal lid 14 to the outside of the metal lid 14.

Each of the section wires 26 is soldered to one of six section contacts 28 spaced around the periphery of the metal lid 14. The section contacts 28 extend through the metal lid 14 and are fixed to the metal lid 14 by means of section contact seals 32. The section contact seals 32 are fluid tight and insulate the section contacts 28 from the metal lid 14. The section contacts 28 provide an electrical path from the inside of the metal lid 14 to the outside of the metal lid 14. The section contacts 28 terminate in contact surfaces 34 on the outside of the metal lid 14.

The multi-value capacitor 10 also includes an external circular insulator disk 40 positioned above the metal lid 14. The insulator disk 40 and the metal lid 14 comprise a safety disconnect mechanism 8. The insulator disk 40 has a center common terminal 42 and six section terminals 44 spaced about its periphery all respectively in alignment with the common contact 24 and the section contacts 28 in the metal lid 14. The upper end of the common contact 24 is fixedly connected by means of a solid, conductive rivet or post 36 to the insulator disk 40 and the associated common terminal 42. Section springs 48 are fixed to the section terminals 44 and form the electrical connection between the section terminals 44 of the insulator disk 40 and the section contacts 28 in the metal lid 14 by the springs 48 resiliently engaging the contact surfaces 34 of the section contacts 28.

As previously noted, the metal lid 14 is dished downwardly (concave) to provide an “over-center” pop-spring (hysteresis) action. When the metal lid 14 is crimped onto the cylindrical metal can 10 to seal the metal can 10, the downward dish of the metal lid 14 pulls the insulator disk 40, by means of the common contact 24 and the solid conductive post 36, toward the metal lid 14 so that the section springs 48 are compressed between the section terminals 44 of the insulator disk 40 and the section contact surfaces 34 of the section contacts 28 around the periphery of the metal lid 14 to form an electrical path between the section wires 26 and the section terminals 44 on the outside of the insulator disk 40.

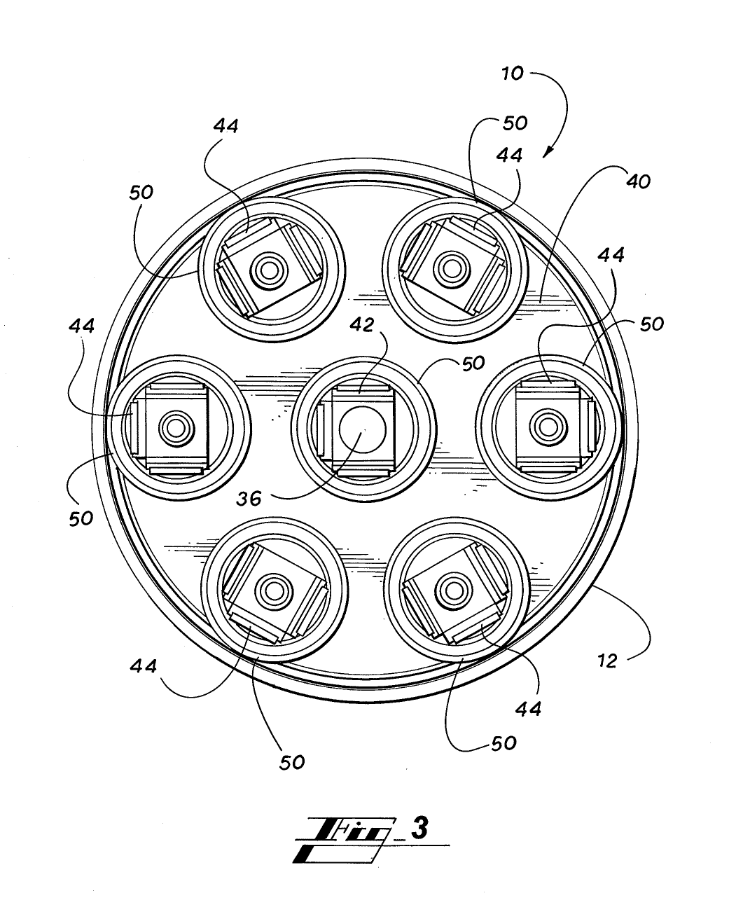

Each of the seven terminals 42 and 44 on the insulator disk 40 has an individual insulator cup 50 formed around it as shown in FIG. 3.

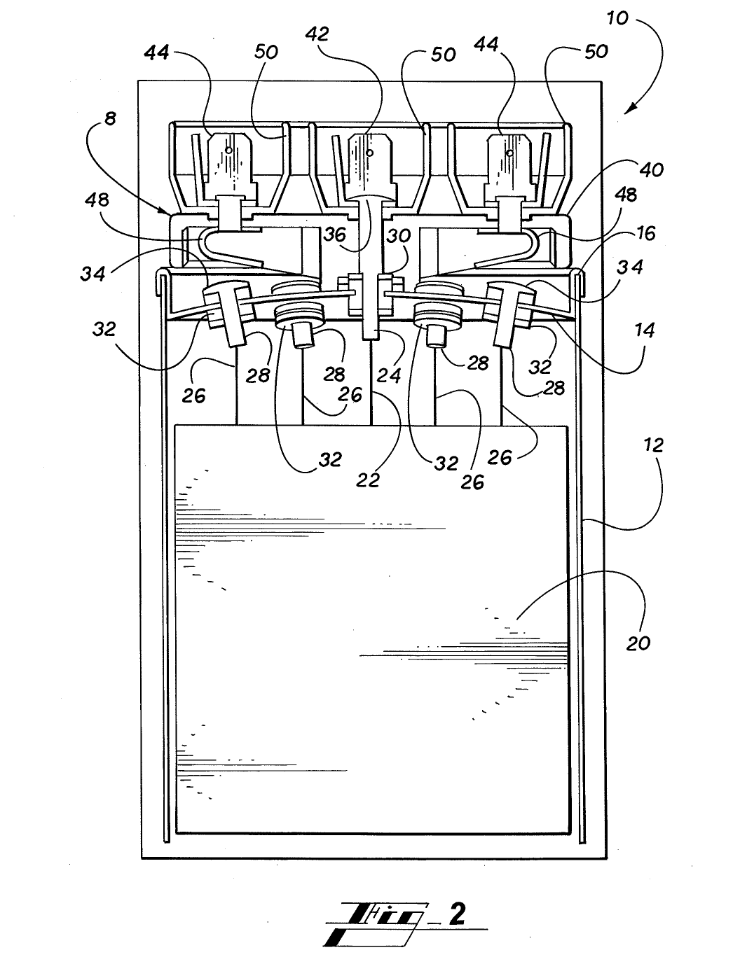

If an overload condition exists with respect to the capacitor, pressure builds inside the sealed metal can 12. Once a predetermined pressure has built within the sealed metal can 12, the metal lid 14 springs from its concave configuration (FIG. 1) to a convex configuration (FIG. 2). When the metal lid 14 springs from its concave configuration to its convex configuration, the common contact 24, fixedly connected to the insulator disk 40 by means of the solid conductive post 36, causes the insulator disk 40 to pop up and thereby simultaneously break the connection between all of the section contacts surfaces 34 of the section contacts 28 and the section springs 48. In another embodiment of the present invention, the insulator disk 40 is pressed into place over the dished metal lid 14 and abuts the solid post 36 so that the insulator disk 40 comes off of the capacitor can 12 completely when disconnecting.

The safety disconnect mechanism 8 may also be used in connection with a single value or a dual value capacitor. For a dual value capacitor, the common contact 24 and the common terminal 42 have the same construction as the multi-value capacitor 10. Instead of six section contacts 28 and six section terminals 44 provided in the multi-value capacitor 10, the dual value capacitor has only two section contacts 28 and two section terminals 44 mounted on the periphery of the metal lid 14 and on the periphery of the insulator disk 40 respectively. For a single value capacitor, the common contact 24 and the common terminal 42 have the same construction as the multi-value capacitor 10. Instead of six section contacts 28 and six section terminals 44 provided in the multi-value capacitor 10, the single value capacitor has only one section contact 28 and one section terminal 44 mounted on the periphery of the metal lid 14 and on the periphery of the insulator disk 40 respectively. Alternatively, the single value capacitor may have a solid nonconductive post positioned at the center of the metal lid 14 and the insulator disk 40 and between the metal lid 14 and the insulator disk 40. The solid nonconductive post replaces the common contact 24, the solid conductive post 36, and the common terminal 42. For the alternative design of the single value capacitor, the common contact and the section contact and the common terminal and the section terminal are mounted on the periphery of the metal lid 14 and on the periphery of the insulator disk 40, respectively.

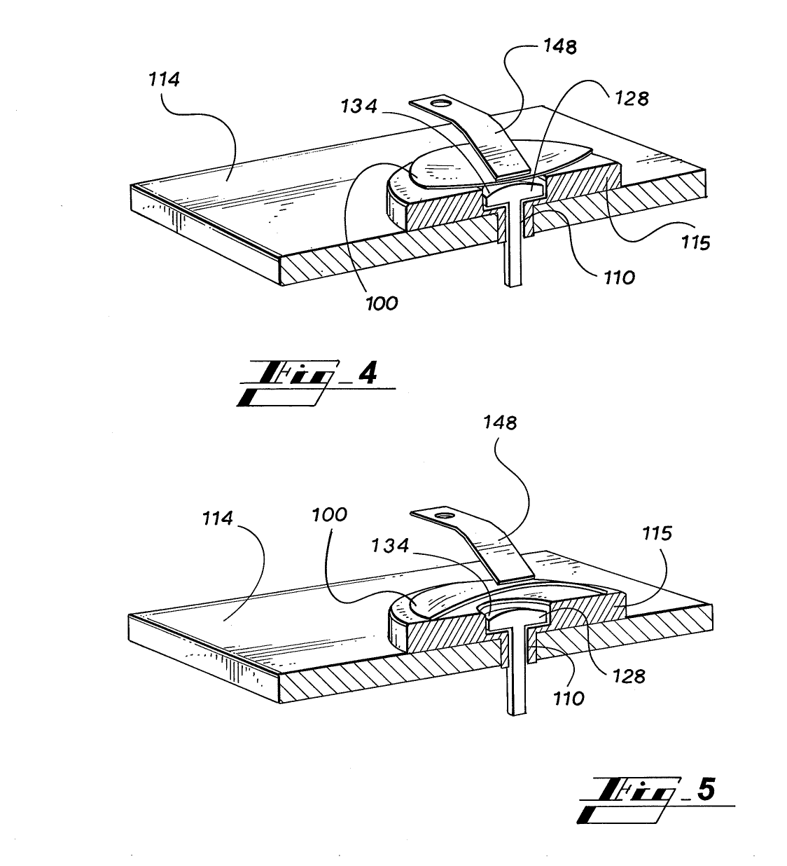

In another embodiment of the present invention shown in FIGS. 4 and 5, each section contact has a snap disk to accelerate disconnecting and to provide redundancy. FIGS. 4 and 5 show a modified capacitor lid 114 with a section contact 128 having a contact surface 134. An insulator 115 separates the section contact 128 from the metal lid 114. The section contact 128 has a channel 110 around its periphery. A conductive disk 100 is mounted above the section contact 28 and is in contact with a section spring 148. The section spring 148 is in turn conductively connected to a section terminal of the capacitor 10 (not shown). In the normal conductive state shown in FIG. 4, the conductive disk 100 is in its concave configuration so that the conductive disk 100 is in contact with the contact surface 134 and seals the channel 110. As pressure builds up in the capacitor can due to a malfunction, the pressure within the can of the capacitor is communicated through the channel 110 to the disk 100. When sufficient pressure has built up, the conductive disk 100 snaps from its concave configuration shown in FIG. 4 to its convex configuration shown in FIG. 5. When the conductive disk 100 is in its convex configuration shown in FIG. 5, the conductive disk 100 no longer contacts the contact surface 134 of the section contact 128, and the circuit through the section contact 128 is interrupted.

In another embodiment of the present invention, an additional gas or liquid with a high pressure/temperature ratio is used to fill the metal can 12 to force disconnection at a predetermined temperature. In another embodiment of the present invention, the dished lid 14 may be made of or may incorporate a bi-metal element to force temperature dependence for disconnection instead of pressure dependency for disconnection.

While this invention has been described with reference to preferred embodiments thereof, it is to be understood that variations and modifications can be affected within the spirit and scope of the invention as described herein and as described in the appended claims.

What is claimed is:

1. A capacitor with a safety disconnect mechanism comprising:
a can containing a capacitive element with a capacitive section and having an opening;
a metal lid for closing the opening and having a concave configuration;
a section contact located in the metal lid, the section contact connected to the capacitive section;
a common contact located in the metal lid, the common contact connected to the capacitive section;
an external insulator disk connected to the metal lid and having a common terminal and a section terminal located in the insulator disk;
a post interposed between the metal lid and the insulator disk; and
a spring element that connects at least one of the terminals located in the insulator disk to at least one of the contacts in the metal lid.

2. The capacitor of claim 1, wherein the solid post connects the common contact to the common terminal.

3. The capacitor of claim 1, wherein the solid post connects the section contact to the section terminal.

4. The capacitor of claim 1, wherein the solid post is connected to the metal lid and abuts the insulator disk.

5. The capacitor of claim 1, wherein the spring element connects the common contact to the common terminal.

6. The capacitor of claim 1, wherein the spring element connects the section contact to the section terminal.

7. The capacitor of claim 1, wherein the metal lid is configured to spring from the concave configuration to a convex configuration when pressure builds in the metal can to a predetermined level.

8. The capacitor of claim 7, wherein the metal can is filled with an insulating fluid with a high pressure/temperature ratio so that the metal lid springs from the concave configuration to a convex configuration when the temperature in the metal can reaches a predetermined level.

9. The capacitor of claim 1, wherein the metal lid is configured to spring from the concave configuration to a convex configuration when temperature in the metal can increases to a predetermined level.

10. The capacitor of claim 1, wherein the section contact has a conductive disk interposed between the section contact and the section spring, wherein the conductive disk has a normal concave configuration that connects the section contact to the section spring, and wherein the conductive disk springs from the normal concave configuration to a convex configuration when pressure within the metal can reaches a predetermined level and thereby disconnects the section contact from the section spring.

11. A capacitor with a safety disconnect mechanism comprising:
a can containing a capacitive element with multiple capacitive sections and having an opening;
a metal lid for closing the opening and having a concave configuration;
a common contact located in the metal lid, the common contact connected to the capacitive section;
a plurality of section contacts located about the periphery of the metal lid, the section contacts connected to the capacity sections;
an external insulator disk connected to the metal lid and having a plurality of terminals located about the periphery of the insulator disk;
a post interposed between the metal lid and the insulator disk; and
spring elements connected to the plurality of terminals located about the periphery of the insulator disk for engaging the plurality of contacts about the periphery of the metal lid.

12. The capacitor of claim 11, wherein the solid post connects the common contact to the common terminal.

13. The capacitor of claim 11, wherein the solid post connects the section contact to the section terminal.

14. The capacitor of claim 11, wherein the solid post is connected to the metal lid and abuts the insulator disk.

15. The capacitor of claim 11, wherein the spring element connects the common contact to the common terminal.

16. The capacitor of claim 11, wherein the spring element connects the section contact to the section terminal.

17. The capacitor of claim 11, wherein the metal lid is configured to spring from the concave configuration to a convex configuration when pressure builds in the metal can to a predetermined level.

18. The capacitor of claim 17, wherein the metal can is filled with an insulating fluid lid with a high pressure/temperature ratio so that the metal lid springs from the concave configuration to a convex configuration when the temperature in the metal can reaches a predetermined level.

19. The capacitor of claim 11, wherein the metal lid is configured to spring from the concave configuration to a convex configuration when temperature in the metal can increases to a predetermined level.

20. The capacitor of claim 11, wherein the section contact has a conductive disk interposed between the section contact and the section spring, wherein the conductive disk has a normal concave configuration that connects the section contact to the section spring, and wherein the conductive disk springs from the normal concave configuration to a convex configuration when pressure within the metal can reaches a predetermined level and thereby disconnects the section contact from the section spring.
